(19) United States
(12) Patent Application Publication
(10) Pub. No.: US 2012/0130736 A1
(43) Pub. Date: May 24, 2012

(54) SYSTEMS AND METHODS INVOLVING PHYSICIAN PAYMENT DATA

(75) Inventors: George Dunston, Jersey City, NJ (US); Kirt Johnson, Hartland, VT (US)

(73) Assignee: Obsidian Healthcare Disclosure Services, LLC, Brooklyn, NY (US)

(21) Appl. No.: 13/360,651

(22) Filed: Jan. 27, 2012

Related U.S. Application Data
(63) Continuation of application No. 12/605,301, filed on Oct. 23, 2009.
(60) Provisional application No. 61/108,154, filed on Oct. 24, 2008.
(60) Provisional application No. 61/121,705, filed on Dec. 11, 2008.
(60) Provisional application No. 61/150,321, filed on Feb. 6, 2009.
(60) Provisional application No. 61/179,720, filed on May 20, 2009.

(51) Int. Cl. G06Q 50/22

(52) U.S. Cl. 705/2

(57) ABSTRACT

Methods and systems of managing physician payment data (PPD) may involve a data compilation system for compiling physician payment data from multiple sources; a data processing system for processing the compiled physician payment data; a data management system for creating a searchable database from the processed physician payment data; and a data distribution system for providing access to the searchable database. Exemplary embodiments of the invention may include a computer-implemented system for automated data compilation, processing, management, analysis, and distribution, such as facilitating online input, output, access and retrieval of PPD using software accessed via a network portal on the Internet. Numerous other aspects are provided.

### CROSS-REFERENCE TO RELATED APPLICATIONS

This application is a Continuation application of, and claims the benefit of, U.S. Non-Provisional patent application Ser. No. 12/605,301, filed 23 Oct. 2009, titled “Systems And Methods Involving Physician Payment Data” (“the '301 application”) (Attorney Docket No. 10007-0006), which is incorporated by reference herein in its entirety for all purposes.

The '301 application, and this application by extension, claims the benefit of U.S. Provisional Patent Application Ser. No. 61/108,154, filed 24 Oct. 2008, titled “Systems And Methods Involving Physician Payment Data” (“the '154 application”) (Attorney Docket No. 10007-0002), which is incorporated by reference herein in its entirety for all purposes.

The '301 application, and this application by extension, also claims the benefit of U.S. Provisional Patent Application Ser. No. 61/121,705, filed 11 Dec. 2008, titled “Exemplary Embodiments Of Aspects Of Systems And Methods Involving Physician Payment Data” (“the '705 application”) (Attorney Docket No. 10007-0003), which is incorporated by reference herein in its entirety for all purposes.

The '301 application, and this application by extension, further claims the benefit of U.S. Provisional Patent Application Ser. No. 61/150,321, filed 6 Feb. 2009, titled “Further Exemplary Embodiments Of Aspects Of Systems And Methods Involving Physician Payment Data” (“the '321 application”) (Attorney Docket No. 10007-0004), which is incorporated by reference herein in its entirety for all purposes.

The '301 application, and this application by extension, additionally claims the benefit of U.S. Provisional Patent Application Ser. No. 61/179,720, filed 20 May 2009, titled “Additional Exemplary Embodiments Of Aspects Of Systems And Methods Involving Physician Payment Data” (“the '720 application”) (Attorney Docket No. 10007-0005), which is incorporated by reference herein in its entirety for all purposes.

### BACKGROUND

1. Field of the Invention

Embodiments of the invention described herein pertain to the fields of data collection, data compilation, data analysis, data management, data distribution, and regulatory compliance. More particularly, but not by way of limitation, the invention pertains to physician payment data, such as data addressed in the proposed Physician Payments Sunshine Act and similar provisions in the pending 2009 health care reform legislation. Embodiments of the invention are directed, for instance, to apparatus and methods for collecting, analyzing, managing, distributing such physician payment data.

2. Description of Related Art

Healthcare professionals, such as physicians, commonly receive payments, both monetary and in-kind, from various sources. First, for medical services rendered to patients, many physicians receive compensation directly from their patients. Many physicians also receive payments from their patients' health insurance companies after filing a claim. Such claim-based compensation typically adheres to standardized billing codes and is tracked accordingly by conventional systems and computer software designed for processing and settlement of health insurance claims. For instance, US Patent Application Publication US 2005/0192839 A1 to St. Jacques discloses a conventional system and “method for managing medical insurance claim's processing and bill payments.” (St. Jacques, Abstract). In addition, US Patent Application Publication US 2002/0032583 to Joao discloses a computer implemented method for managing an insurance claim payment by a payer to a provider of medical services. (Joao, Abstract).

Many healthcare professionals also receive payments for reasons unrelated to health insurance claims. As part of their normal marketing and research activities, pharmaceutical and medical device companies make payments to physicians (both monetary payments and in-kind benefits) in exchange for services and attendance at medical education events. For instance, a physician may be compensated for participation in a medical conference or in a clinical study. Moreover, the physician might receive in-kind payments, such as meals, airfare, room and board, just to attend a meeting. The aggregate of these monetary and in-kind payments is referred to as aggregate spend or “Physician Payments.” As used herein, “physician payments” is defined to include all payments made to healthcare professionals (including non-physicians) (referred to generally as “recipients”), in their capacity as such, excluding payments based on insurance claims for rendering of healthcare. Such payments may include, for instance, (i) cash or a cash equivalent; (ii) in-kind items or services; (iii) stock, a stock option, or any other ownership interest, dividend, profit, or other return on investment; or (iv) any other form of payment or other transfer of value. “Physician payment data” (PPD) likewise is defined to include data related to physician payments only. As such, PPD does not include any and every payment to a physician for whatever reason, and in particular, PPD does not include, for example, payments based on insurance claims for compensation for treatment.

Unlike insurance claim data, physician payment data will include information detailing a healthcare professional's business relationships not related to treatment of patients. As proposed in the Physician Payments Sunshine Act of 2009. an exemplary dataset of PPD may include the following information: (i) The name of the covered recipient; (ii) The business address of the covered recipient and, in the case of a covered recipient who is a physician, the specialty and Medicare billing number of the covered recipient; (iii) The value of the payment or other transfer of value; (iv) The dates on which the payment or other transfer of value was provided to the covered recipient; (v) A description of the form of the payment or other transfer of value; (vi) A description of the nature of the payment or other transfer of value, and (vii) If the payment or other transfer of value is related to marketing, education, or research specific to a covered drug, device, biological, or medical supply, the name of that covered drug, device, biological, or medical supply. Moreover, exemplary descriptions of the nature of payment might identify a payment as: (i) consulting fees; (ii) compensation for services other than consulting; (iii) honoraria; (iv) a gift; (v) entertainment; (vi) food; (vii) travel; (viii) education; (ix) research; (x) a charitable contribution; (xi) a royalty or license; (xii) a current or prospective ownership or investment interest; (xiii) compensation for serving as faculty or as a speaker for a continuing medical education program; or (xiv) a grant. Examples also might include speaking fees, dividends, profit distributions, stock, or stock options.

In contrast to compensation from insurance claims, these non-insurance-claim-based payments to physicians from industry sources historically were not tracked, let alone coded for standardized categorization and analysis. As such, no conventional system existed to manage such physician payments. Over the past several years, there has been increasing concern on the part of physicians, patient groups, state and federal governments and the media about the potential influence exerted by the healthcare industry through physician payments. An expression of this concern included the introduction of federal legislation, The Physicians Payments Sunshine Act S.301 and related provisions in the 2009 pending health reform legislation.

As summarized by the Congressional Research Service of the Library of Congress, the Physicians Payment Sunshine Act of 2009, as proposed in Senate bill 301: “Amends part A (General Provisions) of title XI of the Social Security Act to provide for transparency in the relationship between physicians and applicable manufacturers with respect to payments and other transfers of value and physician ownership or investment interests in manufacturers. Requires any manufacturer of a covered drug, device, biological, or medical supply that makes a payment or another transfer of value to a physician, a physician medical practice, or a physician group practice to report annually, in electronic form, specified information on such transactions to the Secretary of Health and Human Services. Requires any such manufacturer, or related group purchasing organization, also to report annually to the Secretary, in electronic form, certain information regarding any ownership or investment interest (other than in a publicly traded security and mutual fund) held by a physician (or an immediate family member) in the manufacturer or group purchasing organization during the preceding year. Prescribes administrative penalties for failure to comply with these requirements. Requires report submission procedures to ensure public availability of required information on a website.”

The payers targeted for disclosure by the legislation are those whose payments could create a conflict of interest for healthcare professional recipients, which might include physicians, medical practices, group practices, hospitals, etc. According to the S.301 bill, “The term ‘applicable group purchasing organization’ means a group purchasing organization (as defined by the Secretary) that purchases, arranges for, or negotiates the purchase of a covered drug, device, biological, or medical supply. The term ‘applicable manufacturer’ means a manufacturer of a covered drug, device, biological, or medical supply.” Although the 2009 Senate bill 301 was not enacted, similar legislation was enacted in 2010 as the Physician Payment Sunshine Provision of the Patient Protection Affordable Care Act (H.R. 3590).

There is a need for business processes or systems that compile, analyze, manage, and distribute nationwide physician payment data in a coherent, efficient, centralized, and standardized manner, and in compliance with regulatory requirements.

### SUMMARY

In a first aspect of the invention, a computer-implemented method of transforming and managing physician payment data for payments made to healthcare professional recipients by applicable group purchasing organizations or applicable manufacturers is provided, wherein the method includes: compiling the physician payment data from multiple sources into compiled payment data; transforming the compiled payment data into transformed payment data that conform to a desired format of a computer database; creating a computer database from the transformed payment data; processing the transformed payment data into processed payment data; and providing access to the computer database.

In a second aspect of the invention, a computer-implemented system of transforming and managing physician payment data for payments made to healthcare professional recipients by applicable group purchasing organizations or applicable manufacturers is provided, wherein the system includes computer hardware programmed to: compile the physician payment data from multiple sources into compiled payment data; transform the compiled payment data into transformed payment data that conform to a desired format of a computer database; create a computer database from the transformed payment data; process the transformed payment data into processed payment data; and provide access to the computer database.

In a third aspect of the invention, a computer-implemented process of organizing physician payment data for payments made to healthcare professional recipients by applicable manufacturers is provided, wherein the process includes: compiling identification data on the healthcare professional recipients from multiple sources into compiled recipient data; transforming the compiled recipient data into transformed recipient data that conform to a structured format of a recipient database; creating a recipient database from the transformed recipient data; processing the transformed recipient data into processed recipient data; compiling the physician payment data from multiple sources into compiled payment data; transforming the compiled payment data into transformed payment data that conform to a desired format of a payment database; creating a payment database from the transformed payment data; processing the transformed payment data into processed payment data; and relating the recipient database and the payment database.

In a fourth aspect of the invention, a method of managing physician payment data is provided, wherein the method includes: compiling physician payment data from multiple sources; processing the compiled physician payment data; creating a searchable database from the processed physician payment data; and providing access to the searchable database.

In a fifth aspect of the invention, a system of managing physician payment data is provided, wherein the system includes: a data compilation system to compile physician payment data from multiple sources; a data processing system to process the compiled physician payment data; a data management system to create a searchable database from the processed physician payment data; and a data distribution system to provide access to the searchable database.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

By reference to the appended drawings, which illustrate exemplary embodiments of this invention, the detailed description provided below explains in detail various features, advantages and aspects of this invention. As such, features of this invention can be more clearly understood from the following detailed description considered in conjunction with the following drawings, in which the same reference numerals denote the same elements throughout. The exemplary embodiments illustrated in the drawings are not intended to be to scale and are not to be considered limiting of its scope, for the invention may admit to other equally effective embodiments.

FIG. 1 depicts an exemplary embodiment of a business system implementing an exemplary business process, both in accordance with the present invention.

FIG. 2 depicts an exemplary embodiment of a data field hierarchy in a software application component of a business system implementing an exemplary business process, each in accordance with the present invention.

### DETAILED DESCRIPTION

Aspects of the invention are directed to a unified reporting system for disclosure of data relating to payments to healthcare professionals from industry. Aspects of the invention seek to overcome challenges arising, for example, from each company describing these payments in a different manner, even though similarities may exist in the ways certain activities are described. Additional aspects of the present invention allow industry payments to healthcare professionals to be rapidly reported in real-time through electronic means in a unified system that reports data across companies.

More generally, exemplary embodiments of the invention involve business systems and methods relating to an internet-enabled electronic system to collect, organize, analyze and report data related to payments to physicians and other healthcare professionals by pharmaceutical, medical device, and medical supply companies. Aspects of the present invention may allow for more efficient collection of physician payment data by healthcare institutions, healthcare companies and government agencies, and it may facilitate rapid, selective, and secure disclosure through electronic means.

In accordance with the present invention, an exemplary embodiment electronically categorizes payments from Healthcare Product Manufacturers to physicians into standardized categories of payments. This categorization allows electronic schedules of payments from different companies to be combined in a standardized electronic reporting system. Categorization may be accomplished, for instance, using a script that recognizes certain keywords within a written payment description to assign an accurate categorization to each payment. An exemplary embodiment may include, for instance, eighteen payment categories.

The possible panoply of information associated with such physician payments (e.g., who, what, where, when, how, how much, etc.) broadly is referred to as Physician Payment Data (“PPD”). Until recently, Physician Payment Data was not publicly disclosed at all. In the past few years, a few states have passed laws that provide for limited disclosure of PPD, but the introduction of new federal legislation reflects a strong need for an efficient and effective method for the complete and fair disclosure of Physician Payment Data. Additionally, healthcare product manufacturers have faced increased scrutiny over physician payments and have been subject to fines reaching into the hundreds of millions of dollars arising out of federal enforcement actions for perceived inappropriate payments. Accordingly, healthcare organizations have a common need for a cost-efficient, effective, and compliant platform that organizes Physician Payment Data and identifies those payments which could lead to potential risk.

With healthcare industry physician payment disclosure emerging as a priority, many hospitals and medical educational institutions are facing increasing pressure to ensure that their physicians and researchers are operating at the highest levels of ethical behavior in terms of their relationship with the pharmaceutical and medical device industries. Recently, there have been incidents of certain high profile researchers at major academic institutions who have been cited in the news media for failure to disclose payments received by industry to their institutions. Additionally, several state agencies have received legislative mandates to collect PPD from industry; of these states, only three, Massachusetts, Minnesota and Vermont, have made efforts to post this information on the Internet. To the extent that Physician Payment Data has been posted online by state agencies or individual companies, the PPD have been presented in the form of either a static registry of non-standardized, loosely formatted Excel spreadsheets presented in the same manner as submitted by the individual companies, or in a disaggregated form that requires the user do complete further calculations in order to assess the total number of payments reported for each healthcare professional. Such manners of presentation make it difficult to form a composite picture of how each individual physician is paid across companies, and how the payments received by such physicians compare to payments received by other similarly-situated physicians.

In recent years, there has been increased pressure on healthcare institutions, medical schools, hospitals and academic medical centers to effectively manage the real and apparent conflicts of interests created by Physician Payments. Most of these institutions have instituted reporting processes that primarily rely on paper filings made by physicians and reported to a hospital administrator or compliance officer. Each facility may well collect different information in different forms, making cross-facility comparisons challenging. Furthermore, based on experience with hospital administrators, it is often unclear how this method of reporting is enforced or what level of analysis is conducted on the payment data. After all, if no analysis is performed on the data to determine what potential conflicts of interest exist, collection of the data is futile. In recent years there have been some high profile failures of institutional reporting schemes that have attracted media scrutiny at large research institutions such as Harvard University and the University of Wisconsin.

At least several key reasons exist why a comprehensive platform for the reporting of Physician Payment Data has not been developed to date. One reason is the lack of availability of the data. A second reason is the organizational and commercial relationships among the stakeholders of Physician Payment Data that hinder the wholesale sharing of Physician Payment Data between industry, institutions, government agencies and physicians. The few existing electronic systems for reporting PPD from multiple companies do not allow for deeper analysis of the PPD, such as a graphical display of payment data or comparisons of aggregate PPD. Thus, previous reporting systems are static registries of payments on a company-by-company basis. Where data are reported across companies, there is no standardization of the type of payments so it is difficult to compare payments from one company to another. Accordingly, its use as a PPD disclosure and compliance management system is limited.

Another reason that a comprehensive platform previously has not been developed is that Physician Payment Data is held in a number of different forms by various stakeholder groups that have not yet established effective methods for sharing these data. A primary source, and often the most accurate source, of the data is the healthcare company itself, which records the payment data in its general ledger systems. For the most part, such companies have not disclosed these data, online or elsewhere, unless required to by state law or court order. To the extent that federal law may change this to require companies to disclose some data, the chief limitation of company-by-company disclosure is that each company can only disclose its own data on its individual web platform. Disclosure of PPD specific to an individual company does not facilitate automatic online comparisons to other companies' data.

As an independent reporting entity, each healthcare professional receiving the payments serves as a second source of the data. Many of these professionals are required to report these payments to their employers. For the most part, these reporting requirements are employment-related and carried out via paper filings. Each institution typically handles the payments according to its own individual conflict of interest procedures. As a result, to the extent that the professional-provided data actually are collected, let alone analyzed, there is no efficient way to analyze these data across institutions.

A third stakeholder group that potentially has access to these data is the government (both state and federal). Government collection of these data has several key limitations, above and beyond the limitations mentioned for the first two stakeholders. First, at the state level, each state agency can only collect data for that state, which does not allow for national level data analysis (mirroring the national marketplace for pharmaceuticals). Secondly, with the limited exception of Massachusetts, Minnesota and Vermont discussed above, the states have not disclosed these data on the internet. Indeed, a number of states that are collecting the data are not disclosing such data in electronic format at all, which effectively is preventing these data from getting to patients in these states, let alone anyone else. In addition, no agreement appears to exist between states regarding what specific information to collect, how it is to be arranged and formatted, how it is to be submitted, and how it might be published, if ever.

### Exemplary Embodiments

As described below, exemplary embodiments of the invention are directed to business systems and methods relating to an online system to collect, organize, analyze and report Physician Payment Data. Select details of the exemplary embodiments are provided herein, and additional details of aspects of the invention may be found in the applications previously incorporated by reference. For instance, exemplary embodiments may include electronic structuring of a database into organizations that can be ordered into a hierarchical structure for online reporting purposes, as disclosed in the '321 application. The '321 application also discloses exemplary processes and user interfaces for the management and organization of physicians into groups. Exemplary embodiments also may include de-duping and database administrative tools adapted to store and edit data and to assign physician records to multiple organizations, as disclosed in the '720 application. The '720 application also discloses exemplary embodiments using Levehnstein Distance matching engines for the Physician Name/Address information and the Organizational Name/Address information. Furthermore, details of processes for allowing search by specialty using matching with National Plan Provider and Numeration System Identifier, as well as details of systems, procedures, user interfaces and online catalogs for importing spreadsheets and flat text files into a database, are discussed in the '720 application. Other exemplary embodiments may include a user interface design for comparing payments across physicians and organizations using a percentile breakdown of data and peer groupings, as disclosed in the '705 application. Further exemplary embodiments may include a word matching system for categorizing payments by activity, as presented in the '154 application.

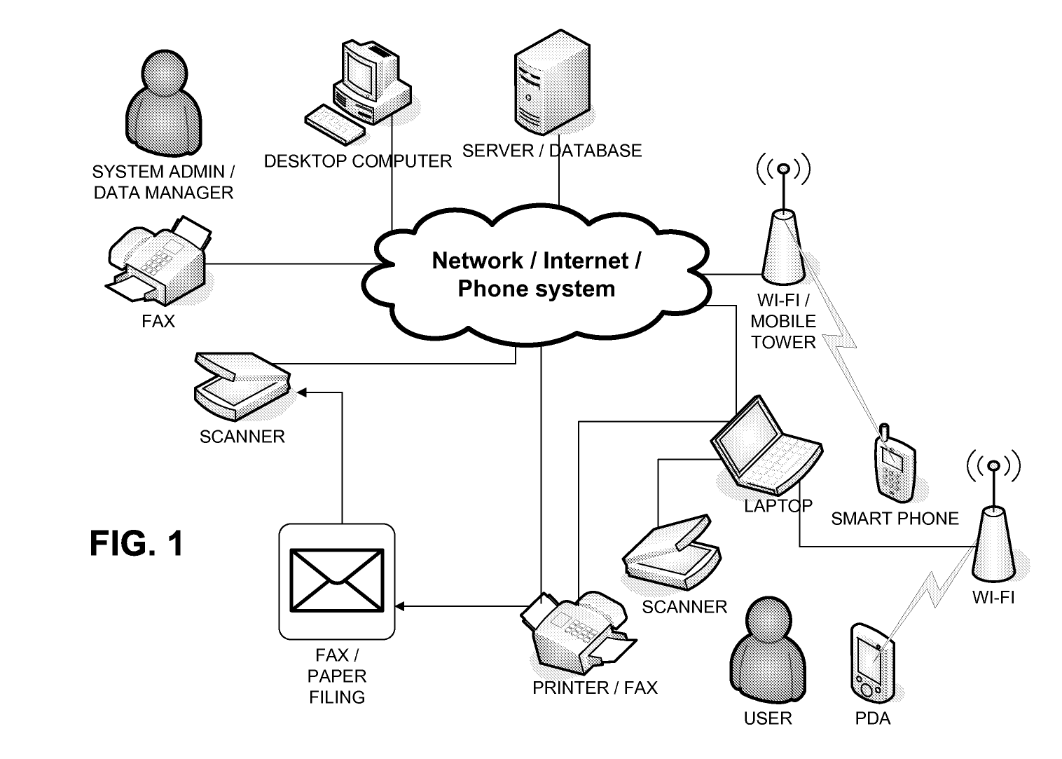

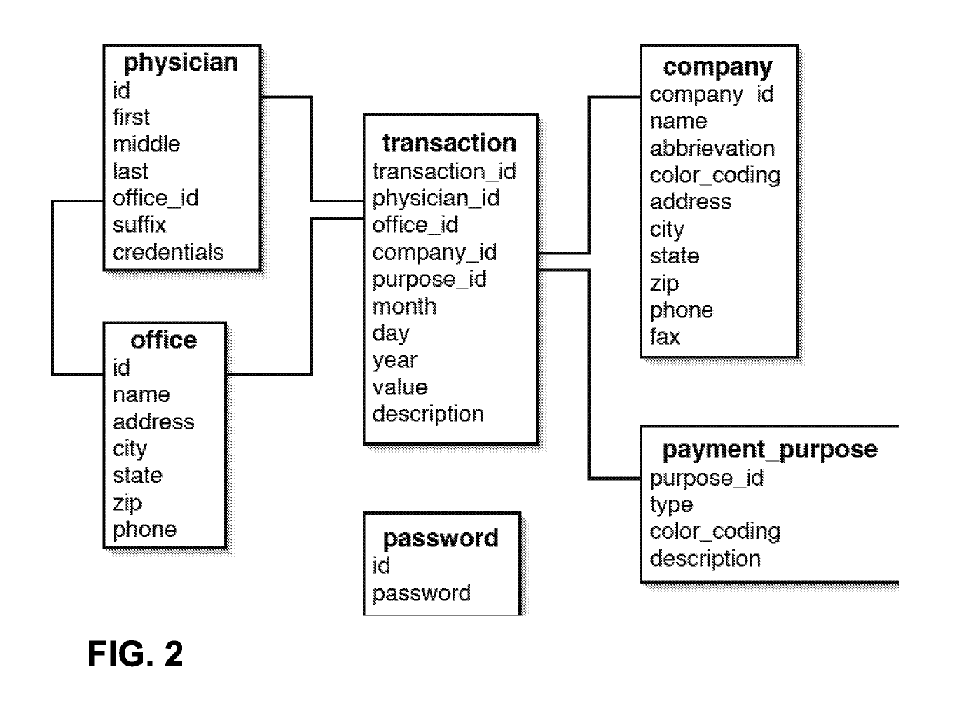

Referring to FIG. 1, an exemplary business system is depicted in a simplified form in accordance with the present invention. The business system is designed to implement an exemplary embodiment of a business process in accordance with the present invention. The business system and business process may involve a remote user, who may be, for instance, a physician, a hospital employee, a pharmaceutical company employee, or a patient, who uses various modes of accessing and/or delivering PPD stored in the PPD database. A user may, for instance, access PPD using a laptop, a mobile smart phone, and/or Wi-Fi personal data assistant (PDA). Likewise, a user may deliver PPD using, for example, a computer, a fax machine, a printer, a scanner, a mobile smart phone, and/or a Wi-Fi PDA. The user also may input the PPD directly by typing the data into appropriate fields in a graphic user interface (GUI). The GUI may present the user with a data field hierarchy for convenient entry of the PPD. FIG. 2 depicts an exemplary embodiment of a data field hierarchy in a software application component of a business system implementing an exemplary business process, each in accordance with the present invention. The PPD may be exchanged in either direction either electronically or tangibly, such as via printed reports or hand-written notes.

The PPD database may reside in a server maintained by a system administrator or data manager employed by a PPD Management Entity implementing the business system or business process. The Management Entity may use various forms of technology to receive, acquire, process, store, analyze, protect, and distribute PPD. Such technology typically may include scanners, fax machines, computers, computer networks, and appropriately configured software. Much of the present invention would be implementable in appropriately configured software executed or accessed by compatible computer hardware. Exemplary aspects of business systems and business processes according to the invention are provided in greater detail below. The descriptions and examples below are only exemplary in nature and not intended to limit the present invention or the range of possible variations of its embodiments or implementations. For instance, to the extent that any statement mentions specific types, sizes, or natures of data fields, code languages, or time frames, the present invention is not limited to the types, sizes, ranges, nature, fields, languages, or time frames mentioned in such statements.

Exemplary Aspects

The invention involves leveraging the capabilities of the internet to provide an independent, centralized, standardized platform operated by a disinterested third party, but also a trusted partner, for the collection, disclosure and analysis of Physician Payment Data. A first part of the present invention allows for large amounts of Physician Payment Data from disparate sources to be loaded into a common database. As part of the data loading process, each individual record may be electronically tagged so its source can be quickly and easily identified. Additional data also may be loaded into the database through a customized interface, which may be automatically linked to the professional and his or her institution through a personalized login. Other aspects of the invention involve the use of specialized electronic interfaces, reviewed by trained personnel to improve data quality, such as reconciling duplicate data and resolving errors in source data. At a disclosure stage, a user may be able to review, for example, the user's payment data across companies and organized by activity. The user also may be able to see, for instance, comparisons between the aggregate payments received by a professional in a given year and the median received by all professionals in the local area (e.g., zip code), on a statewide basis and/or on a nationwide basis.

Further aspects of the invention provide for various types of analysis at the institutional level using internet enabled querying engines. Practically speaking, the data may be filtered, sorted, and grouped for presentation according to any data category present in the data, or derivative categories or searches derived from categories present in the data. A derivative category might include, for example, monetary payments not made in US Dollars. Such a derivative category would be derived from the categories relating to monetary payments and specific currency of payment. Insofar as “non-US Dollar” does not specify a national currency, it would not be appropriate as a direct category. Instead, currency type would be the direct category in this example.

Data Collection

Aspects of the invention facilitate creation of a comprehensive aggregation of Physician Payment Data available on the internet. As soon as new data becomes publicly available, either directly by submission by a reporting entity or a reporting entity's agent, or indirectly by publication or regulatory filing, these data may be incorporated into the database through a loading interface that allows for rapid loading of electronic records. Unformatted paper records, for example, may be scanned and undergo optical character recognition (OCR) to identify, parse and concatenate their contents. The present invention may incorporate an easy-to-use interface that allows healthcare professionals to quickly and easily record payments received from industry and have this information incorporated into a customized database accessible by each individual organization's administrative and compliance staff. This interface may include pre-programmed pull-down fields which may allow payment data to be entered rapidly into the database in a standardized fashion.

Data Quality Improvement

Insofar as data quality (e.g., completeness and accuracy) is a chief limitation of the currently available Physician Payment Data provided online, aspects of the invention may combine the expertise of trained staff with proprietary data merging algorithms to provide cleansed, complete and comprehensive data that give the user a clear picture of how their professionals are being compensated by industry. For instance, staff may be able to access the database through interfaces that may be specifically designed to allow for: (1) the reconciliation of misidentified professionals; and (2) the resolution of incomplete or incorrect data.

Data Organization

According to other aspects of the invention, each payment may be electronically categorized into standardized categories of activities (e.g., speaking, education, preceptorships, honorarium, consulting, advisory boards, travel, meals, research, gifts, training, grants and pricing). An exemplary Activity Key is provided in the '154 application. This categorization may be accomplished, for instance, through one or more scripts that recognize certain keywords within a written payment description and assign an accurate categorization to each payment. This standardization allows electronic schedules of payments from different companies to be reported in a unified format. Other techniques may be employed as well, such as electronic word matching, which allows company descriptions to be conformed to a standard description.

Search Engine

Aspects of the invention may leverage the full capabilities of internet-enabled searching to help resolve the issue of Physician Payment Data disclosure. In accordance with possible authorization parameters and possible user roles, a user may be allowed to search among thousands of physicians by various direct categories or derivative categories, such as by first or last name, institution, industry payer, city, state, zip code, and physician specialty.

Physician Level Reporting

Embodiments of the invention allow for a major step forward in the presentation of Physician Payment Data through, for example, use of physician level reporting that may provide the user with a “line of sight” for payments made to individual physicians across companies. This information may be used to generate a “Physician Payment Report” that may give the user a more complete picture of a professional's relationship to industry. For instance, it may indicate how much was paid, by whom, when, for what activity and how those payments compared to other local physicians.

Advantages

With the disclosure of potential conflicts of interest arising from healthcare industry physician payments emerging as a priority, many hospitals, medical schools, and other healthcare provider organizations are facing increasing pressure to ensure that their physicians and researchers are operating at the highest levels of ethical behavior in terms of their relationships with industry. Aspects of the invention may provide institutional subscribers with the ability to compare and contrast their professionals' internal compliance disclosures with those of industry and other institutions. It also may provide administrators with the ability to ascertain if their professionals' activities and financial receipts conform to their internal standards and are in line with those received by professionals at other institutions.

Exemplary embodiments of the invention may provide professionals with the opportunity to see her or his payment data online in a clear, understandable and organized format that can be presented to patients, or anyone else who has questions regarding the professional's relationship with industry. The professional user can also use the reporting function to compare her or his payment data to similar data for colleagues, such as other professionals in her or his medical group, clinic, university, specialty, or geographic area. The invention's use of a comprehensive web-based platform may allow a user, such as a professional subscriber, for the first time, to access data on a nationwide level.

For the healthcare industry, the invention may remove some of the complexity and cost from compliance with state and federal laws concerning the disclosure of physician payment data. A company simply may upload the payment data to the online platform and have immediate access to an advanced analytical framework that categorizes and formats payments specifically for review by industry compliance professionals. Such a platform may allow the company to see its payments compared not just against its own prior payment data, but also to payments made by other companies across the industry, with data organized, for example, by individual physician, institution, medical group, geography, specialty and/or therapeutic area.

The invention also may facilitate fulfillment of the disclosure needs for industry and government agencies by facilitating public disclosure through its secure online portals. Aspects of the invention's web based approach allow industry and government agencies to update the information related to their payment data online and in “real-time” so that the data presented to the public preferably are complete and not subject to misinterpretation. Payer-provided PPD may be cross-checked against payee-provided PPD, as a possible way of catching, for example, missing payments, mischaracterizations, and/or data entry mistakes.

Moreover, exemplary embodiments of the invention may empower patients to quickly access online up-to-date information on the payments received by her or his physician in a simple readable format, which may include background information regarding the companies making the payments and the drugs and devices that they sell.

Overview of Exemplary System and Process

An exemplary system (the “System”) and an exemplary process that the System implements are described below. The System may be an online application for the collection and presentation of data related to payments by Pharmaceutical, Medical Device and Hospital Supply Companies to Healthcare Professionals, Medical Groups, Medical Schools and Clinics. The System loads raw data in electronic form (e.g., electronic spreadsheets, HTML documents, electronic ledgers) into a proprietary database that allows for the presentation of the data online in number of interactive formats, such as presentation of the data on an individual basis for each healthcare professional.

The System may employ software or other computer code to load data from electronic sources. Two aspects of this code may include: (1) determining which columns in a spreadsheet file goes where in the database; (2) detecting which entries in the data correspond to the same doctor, office, or pharmaceutical company. An exemplary embodiment of a data schema in accordance with the invention is provided in the '321 application.

The database may include a number of tables, each table describing a different type of data. Each table preferably contains a number of fields that correspond to attributes of that table. The physician table preferably has fields for first name, last name, etc. A single record in a table is an assignment of values to all the fields in the table. Relationships between the tables may be determined by linking an attribute of one table to that of another (often referred to as foreign keys).

An exemplary database may include 11 tables: physician, office, company, payment_nature, payment_type, specialty, organization unit, account_organizational_unit peer, drug_brand, account, organizational_unit_level, and transactions. The physician table holds the data about each physician. An exemplary physician table has 13 fields: a unique identifier (a number unique for each doctor), a first, middle and last name, a suffix, an office id (the office where this doctor works), credentials, address, city, state, zip code, phone, specialty, and date of information. The office table holds the data about each office. Since several physicians may work in the same office, the data may be separated out so that the database doesn't store excess data. An exemplary office table has 7 fields: a unique identifier, name, address, city, state, zip and phone. The company table holds information about each pharmaceutical company. An exemplary company table has 8 fields: a unique identifier, name, address, city, state, zip, phone and fax. The payment_nature table contains information about the nature of payment. In HR 5606 payment nature is specified as compensation, food, travel, etc., so an exemplary payment_nature table mirrors these categories. The payment_purpose table contains information about the purpose of the payment. The transaction table includes any exchange of money. An exemplary transaction table includes 10 fields: a transaction id that uniquely identifies the transaction, the physician or organization id (the doctor or organization who got paid), the company id (the company who paid), the payment nature id (the nature of the payment), the id of import file including the transaction, the payment purpose id (why was the payment made), the day, month, and year, and a value.

An exemplary System includes a program that categorizes each payment into a payment type this includes a flat text file that has the payment type identifications (e.g., categories 1-15 in the '720 application), payment type (title for each of the 18 classes of payment types), and the payment type description (for each class). The code may take into account the hierarchal nature of the classes when assigning a type to an individual payment. A search interface may allow the user to search for healthcare professionals by first name, last name, city, zip code, state or specialty. Search results may be generated in a text field that allows the user to select and individual physician.

The system generates a Physician Payment Report that may list the following information: the current date, the physician name, the physician address, a scroll text box listing all payments received by the physician (including the payment amount, the year of payment, the payer and the type of payment), the total payments received on an annual basis, a graphical representation of the payments received apportioned by percentage paid by each payer, a graphical representation of the payments received apportioned by type of payment and a graphical representation of total payments on an annual basis compared to median payments paid to all physicians on a zip code, state and national basis.

Data Import System

An exemplary system for end-to-end management of data import and administration is provided. The import process is expected to have 4 stages: (1) acquisition and cataloging of source file(s); (2) initial cleansing of source data into delimited text; (3) automated first-pass import to capture majority of records; and (4) manual second-pass import/reconciliation to address remaining records. Once the data are imported, the data may require ongoing management to update faulty records, trace back to the original source any non-conforming transaction records, and to de-dup any inadvertently inserted duplicate records of any type. In anticipation of the likelihood that these tasks may be handled by multiple people with varying levels of authority, a login and permission system must be set up to enable restrictive access to groups of these processes.

Toolset

An exemplary System may include software a toolset that includes, for instance, the following tools having the following functions: a Source Catalog Tool: Provide storage and organization of raw source data and intermediate materials; an Import Tool: An interface and process to import data from a variety of sources; a Reconciliation Tool: An interface that allows administrators or customers to fix import issues, both manually and automatically; a De-dup Tool: An interface that allows manual de-duping of physician, institution, and company data; and a Track-back Tool: A utility with the ability to track existing transactions back to their source record.

Source Catalog Tool

Source files of public transaction data may be received from many sources, mostly government agencies at various levels and pharmaceutical companies. Administrators need the ability to upload and store these files, as well as add/edit/delete information about these files. The following information may be stored for each source file: binary source file data; original file name; URL of original location (if applicable); provider (company or government)—canonical name/info; state (if applicable); date received; notes/comments.

Each source file may be cleaned and reduced to a delimited text file (“import file”) or in some cases a small set of import files. Administrators may store each import file and link it to its original source file. The following information may be stored: text data of the import file; file name (if applicable); source file id (foreign key to source file data record above); created date; name of person who created file; number of records; mapping strategy; notes/comments. Administrators may configure each import file with a data-mapping algorithm that may govern how it is eventually imported. The requirements for this may be covered under “Import Tool” below.

Import Tool

The Import Tool is responsible for allowing administrators with the right privileges to add records in bulk to the database from delimited text import files. Administrators may be able to view a history of past imports and pending imports that include: source file name; status (complete, in reconciliation, in progress, pending); date imported; number of records imported without a problem; number of updated existing physicians, institutions, companies; number of newly inserted physicians, institutions, companies; number of initially flagged (possible dupes, data errors, etc.) records; number of currently flagged records (in reconciliation) and number of reconciled records; number of discarded (manually only!) records; Aggregate dollar amount of imported transactions; administrator's name who imported the data.

Admins may be able to create/edit/select a mapping strategy for an import file. A mapping strategy is a list of target transaction data points required by the system and which field in the import file may provide that data point. Additionally there may be some text-processing algorithm specified to handle specific fields. An exemplary mapping is provided in the '154 application.

Admins may be able to save and re-use mappings for multiple import files that originate from the same source. Admins may be able to perform “dry-runs” on imports that report how many successful inserts/updates/etc. *would have* occurred, as well as show some sample data and a report on reasons for flagged records, so that admins can debug their mappings. Admins may be able to run imports and then begin to perform reconciliation if needed. Individual records that can't be imported for any reason (see various cases below) may be flagged and not imported into the database.

The import tool may recognize exact matches of existing physicians, institutions, companies, and transactions, to ensure that existing records aren't duplicated. The rules that constitute an exact match may be set up programmatically but may be editable by an engineer without too much trouble. Exact matches preferably result in the following behavior: physician match—use existing physician info as recipient; institution match—use existing institution information as recipient institution; company match—use existing data; transaction match—flag as “possible duplicate.” The import tool may recognize possible matches of existing records and flag them for manual reconciliation. The rules governing this may be programmatically changeable. The import tool may flag any record that fails import for any reason and report on those failed records and reasons.

Reconciliation Tool

Any source record that doesn't succeed completely during import may be flagged by the import process. Any import process with flagged records may be put into status “in reconciliation”. An admin with the right level of privileges may be able to view the “next flagged record” in any import in reconciliation. This view may show the following information, for instance, to aid the admin in reconciling the record: (1) the available fields in the text import record and their raw data; (2) the mapped data points and the resulting data as if it was imported; (3) the reason the import failed; (4) “popup” lookups for existing physicians, institutions, companies, transactions; (5) form fields allowing the admin to override or fix data; (6) buttons “discard”, “skip”, and “reconcile.” Actions taken may update the running count of records imported, skipped, etc. The tool may recognize when all records for a file have been discarded or reconciled and update the status to “complete”.

The tool may allow for “bulk reconciliation”. When an admin makes a set of changes to a record, they may check “apply to all similar records”. The tool may apply the changes that the admin made to that record to any records it comes across that have the same value in the source record. It may attempt to import those records after applying the change, but the tool may re-flag the record again if the change doesn't entirely work. It may not automatically succeed. An example would be payments going to “P Diddy” that fail due to possible match with “Puff Daddy”. The admin determines that they are a match and updates the record and selects “apply to all similar records”. Ten other “P Diddy” records are found and updated, but only five may succeed, the other five may be flagged for other reasons. Because the reconciling admin may be different from the original importer admin, the reconciled record may have a reference to the reconciling administrator.

De-duping Tool

Data that have been successfully imported may need to be updated to remove discovered duplicates. For any existing physician, institution, company, or transaction, an administrator with the correct privileges may be able to identify and correct (delete) a duplicate record and have all database records that reference the duplicate be updated to point to the correct non-duplicate record. The tool may allow simple browsing, searching, and sorting of records. It may allow admins to check a record as the “master” and check a number of other records as “duplicates”, then remove the duplicates and update the orphaned references. Additionally, records may be able to be cleansed and managed (case, address fields, zip codes, etc.). For instance, data may be automatically compared against relevant data in the National Plan and Provider Enumeration System (NPPES) for de-duping as well as cleansing purposes. The NPPES manages and assigns standard unique identifiers, also known as National Provider Identifiers (NPI), for health care providers and health plans that were mandated in the Health Insurance Portability and Accountability Act of 1996 (HIPAA).

The above-mentioned de-duping tool may be included in the data import system, or it may be an independent tool accessed by the import system and other sub-systems. For instance, de-duping activities may be performed in maintenance of the System as new information becomes available that may cause data entries to become duplicative or consolidated. Other de-duping activities are discussed below.

Track-back Tool

In anticipation of possible government inquiries, the System may include a complete and robust audit trail from integrated transaction data back to the sources of that data. All transactions in the system may relate back to a source record in a source file catalog or to manual entry by a logged-in user. For imported transactions, the transaction records may include a reference to the import file and a line-number in that file. Import files may in turn be related to the administrator who ran the import job or the reconciliation. For manually entered transactions, the transaction may contain a reference to the logged-in member who entered it. An administrator may be able to enter a transaction ID and view a report that includes the source file, import file, original importer, import date, and reconciling admin.

An exemplary system may be hosted, for instance, on a Redhat Enterprise Linux 4 machine, running Apache 2, PHP 5, and MySQL 5. Other software platforms and browser configurations may be used as well. Development environments, such as C, Python, Perl, and Java development environments, may be available if needed to support software processes, but it would be preferable to keep hardware and OS dependencies to a minimum.

Exemplary Drug Database

A user may want to find connections between doctors and drugs. After locating a doctor, users preferably may be able to see whether there is a link to a particular prescribed drug. The System may associate clinical studies with drugs; e.g., a clinical study group preferably may be able to be associated with a particular drug. The System may associate additional future capabilities, e.g., look up companies by drug name; find doctors by company/drug relationship. An exemplary search screen preferably offers the ability to search for a physician and a drug together. For instance, there may be a small form labeled “Search for payments related to a particular drug”. As the user types in a drug name, generic name, or NDC number, the available matches in the DRUG_BRAND table (see below) preferably may be displayed in an auto-complete menu. Upon form submission, a new version of the payment report page preferably may be shown for that physician, showing payments by the company(s) that supplies or market the drug selected, payments by activity, and a physician comparison report for that company.

An exemplary Payment Report for Company screen preferably may function just like the payment report screen with the following possible changes. For example, the page preferably may be titled “[Company] Payments to [Physician].” Subtext to the page title preferably may state something to the effect of, “The following payments were made to [Physician] by [Company], which produces or sells [Drug] in addition to other pharmaceutical products. The information here is not exclusively related to [Drug].” The payment listing preferably may not have the “company” column. There preferably may be no “payments by company” graph. The “total payments compared to . . . ” graph preferably may compare (a) total payment amount to the physician by the selected company versus all payments to all physicians (median) by that company, and (b) total payments to the physician by all companies versus all physicians (median). In place of a search button, an “Other [Company] Products” panel preferably may list all the drugs sold by the selected company. As pertains to administration of Clinical Study data, an exemplary Create Group screen preferably may allow the user to select a drug to associate directly with the clinical study.

Website Administration Tools

In accordance with embodiments of the invention, the database may be administered via a website, and the website itself may include various administration tools. Exemplary administrative tools are described below for a physician payment database that tracks, for example, physicians, healthcare organizations, pharmaceutical companies, drugs, and payments made between companies and healthcare providers. Each section below represents a set of features in the administrative area of the site.

Database Statistic Tools

These tools provide administrators of the system with a birds-eye view of the data for one or more states, such as MA, MN and VT. Exemplary statistics include: Total number of physicians in the database (“DB”); Total number of payment transactions in the DB; Total number of companies in the DB; number of highly paid Physicians in DB, grouped; Highest paying company, by state; Highest paid physicians, by state; Total money spent per activity/purpose; number payments, by year and state; and Payment amount totals, by year and state. Other statistics may be derived instead or in addition.

Queries that generate this information may perform SUM( ) or COUNT( ) calculations on records generated from the various criteria that generally scans the entire transaction database. Queries may be performed on every request to the page so the data are always real-time data, which, however, may strain the performance of database. As such, making this data publically accessible might preferably involve showing cached results that were updated offline periodically, e.g., once every “n” minutes, to prevent undue stress on the database.

Physician Data Management Tools

The System may include a Physician Data List Tool that may allow a user to view the physician data currently in the database, organized and sorted by last name, first name. From this screen the administrator may select data for a physician to edit or delete from the system. The System likewise may include a Physician Data Edit Tool that may allow an administrator to update the name and address information for a physician, as well as to update the organizations to which the physician belongs. The tool may allow specifying a relationship to one or more organizations along with start and end dates for each association. Furthermore, the System may include a Physician Data Delete Tool to remove the data for a particular physician from the database entirely. For instance, this tool may remove the record, but not transactions related to that physician or any other data that might have been associated to it. Such a tool preferably is used with great care.

Organization Data Management Tools

The System may include an Organization Data List Tool that may allow an administrator to view the data for one, more, or all the organizations in the database, sorted by name, such as with sub-organizations nested under their parent organizations. In this way, it may give an overview of what organizations are set up in the system and how they relate to one another. For instance, “Norris Cotton Cancer Center” might be nested as a sub-organization under “Dartmouth Hitchcock Medical Center.” The tool also may allow the administrator to choose the data for an organization to edit, delete, or de-duping.

The System also may include an Organization Data Edit Tool that may allow the administrator to edit the name and address of an organization, and/or set its “type” (institution, division, department, clinical study group). From this tool, a user also may change the parent organization under which the organization belongs, allowing arbitrary nesting of organizations.

In exemplary embodiments, the System includes a database that supports an institutional hierarchy. For instance, medical schools and hospitals may want to report on the various departments and divisions inside their institution. While the exact structure of departments and divisions may vary from institution to institution, the database may offer a flexible way to allow institutions to set up divisions and sub-divisions within their organization and use the site tools to work with them independently. Additionally, institutions may be able to do comparative analysis between their departments and similar departments at other institutions. The System also may track associations between physicians and institutions over time. For example, the database may allow doctors to be associated directly with multiple institutions (and/or departments or divisions) simultaneously or over time. A profile of a physician's associations over time may be viewable. Newly received transactions with ambiguous institutional information may be able to use this profile information, where appropriate, to associate physician payments with the proper institutional unit.

More generally, the System may allow the creation of arbitrary groups of physicians, such as to allow the formation of arbitrary groups of doctors that can be reported on at the discretion of the account administrator user. These groups can belong to any department or division within an institution. Physicians within these groups may be able to be labeled with a role. For instance, groups may be identified with rolls like “new doctors,” “residents,” “head nurses,” etc. All reports that can be run for institutions or divisions within institutions may be run for these groups as well. Similarly, the database may support the ability to define groups of doctors participating in a clinical study and record payments to that study or doctors as associated with the study. There also may be the ability to flag a doctor as a “lead physician” in the study.

Drug Data Management Tool

As with similar tools mentioned above, the System may include a drug data list tool and a drug data edit tool to allow an administrator to view the drug database, add new drugs to the list, or update the records of existing drugs.

Physician Data De-Dup Tool

As discussed some above, the System may be configured to identify and analyze duplicate data. In anticipation of importing lots of data, a de-dup tool may be used to identify and analyze physician payment data. For instance, this de-dup tool may be used to identify duplicate entries for an individual physician. This tool would allow administrators and other power users to browse the physician database and tag records as duplicates. For instance, an admin may place a “keep” next to the physician/office record to be kept, and mark a radio button to select the master record and a “duplicate” checkbox to select any number of records that are duplicates of the master record. Each row may be a physician name and an office address, joined by the physician.office id field. Only one master may be selected, but any number of dups can be selected. In some embodiments, a Levenhstein Distance Matching analysis may be performed to assist in the identification of duplicate entries and/or related entries.

When submitted, the form would kick off a series of query statements (e.g., SQL) that would replace all references to the duplicate records with references to the master record. Then the duplicate physician records would be deleted, and their office records would be deleted only if there are no other references to those offices in the system. The tool can go in the list of tools in the admin area under “De-dup physicians.”

As such, the physician data de-dup tool may allow an administrator to consolidate duplicate physician records into a single record. It may allow the administrator to select criteria to match physicians into groups based on similarities in name and address, for instance, and then select one as the “master” and one or more others as the “dupes.” The dupes may be treated as duplicate records and may be removed from the physician data list. The master record may inherit all transactions and memberships in organizations related to the removed dupes.

To improve automated duplicate recognition, any records flagged as duplicates may be copied into the PHYSICIAN_ALIAS database table before they are deleted. These alias records may point to their new master record. As such, the database may track of all records that have been de-duped, which may play a key role in future data imports, outlined below.

Exemplary de-dup procedure logic may be as follows: (1) One master physician record is selected; one or more duplicate physician records (“dupes”) are selected. (2) ORG_UNIT_MEMBER is updated, replacing IDs of dupes with the master ID. (3) TRANSACTION is updated, replacing IDs of dupes with the master ID. (4) PASSWORD is updated, replacing IDs of dupes with the master ID. (5) PHYSICIAN_ALIAS is updated, adding dupes if they aren't already in the table. (6) PHYSICIAN_ALIAS is updated, replacing PHYSICIAN_IDs of dupes with the master ID. (7) PHYSICIAN records that are dupes are deleted. In conjunction with de-duping, physician data may be compared with NPPES data, for instance, to confirm that physician name and address information are correct, and to correct any inaccuracies.

Organization Data De-Dup Tool

The System likewise may include an organization data de-dup tool that may allow an administrator to consolidate multiple duplicate organization records into a single record. For instance, it may use a Levenshtein distance calculation between all the organization records in the database to determine which organizations may be most likely duplicates with another organization. This calculation may be performed on the organization name and address fields, for instance.

Once a set of duplicates are generated, the administrator can go through the list and select pairs to de-dup. The organization selected as the duplicate may be copied to the ORG_UNIT_ALIAS table with a key reference to its master record, and then the original duplicate record may be deleted from the database. As such, the database may track all records that have been de-duped, which may play a key role in future data imports, outlined below.

Exemplary de-dup procedure logic may be as follows: (1) One master org_unit record is selected; one duplicate is selected. (2) TRANSACTION table is updated, replacing records with the duplicate's id with the master's id. (3) ORG_UNIT_MEMBER is updated, placing records with the duplicate's id with the master's id. (4) ORG_UNIT_ALIAS is updated, inserting a new record for the duplicate with a foreign key to the master record. (5) Delete the duplicate ORG_UNIT record, and close the hole in the nested-set node edges left by the deletion.

Searching By Physician Specialty

Searching by physician specialty may allow search results to be limited to certain classifications of healthcare providers, and to healthcare providers that specialize in a given field. This may be done by matching the classification or specialty name (or names) selected by the user to a list of NPI taxonomy codes in the NPI database. For instance, this feature may allow users to perform the following types of searches: (1) All psychiatrists in Vermont; (2) Cardiologists named “Jones”; (3) Registered Nurses in Cardiology; and/or (4) Psychiatrists named “Jones” in Burlington, Vt.

If the search is performed in the “manage groups” area of an exemplary website, this may enable a user to more easily define groups of physicians based on their specialty. A search field “Specialty” may be added to the physician search forms that may be a multiple value auto-complete field. The auto-complete lookup may be done, for example, against the ‘classification’ and ‘specialization’ fields in an NPPES taxonomy table. In some embodiments, user-entered text may match any portion of either field, but the returned list of names preferably may be formatted as “Classification—Specialization” and preferably also may include a special item, “Classification—Any” for any classification match.

Search queries performed with specialties selected preferably may have results that are limited to physicians with those taxonomy codes for the names selected. If the user selects a “Classification—Any” entry, for instance, all the taxonomy codes for that classification preferably may be included in the search query. In some embodiments, a search statement may have an additional join logic applied to it when specialties are present in the search criteria:

Payment Analysis by Institution

The System may include a screen providing “Payment Analysis by Institution” data. Such data preferably may be presented to a logged in institutional administrator. It may be linked to or from an “administrator landing” page. Two central “page-wide” parameters may be provided that determine how corresponding graphs may be drawn, along with a small number of detail parameters that affect a few graphs. The main page-wide parameters (and their associated transaction DB fields) may include, for instance: Year (year); and Companies (company_id).

A “Year Select” pulldown may show all the years for which there are transactions in the database. This value may update all the data on the page to be specific to the year selected. It may force a page-redraw with the proper information. The payment trends graph may span multiple years. It may also be kept static and show all years for which data are present, no matter which year may be selected.

An “Institution” pulldown may be included on the implemented page. Moreover, this page may work with data that may be specific to the logged-in user's institution only. This pulldown may also show corporate divisions within the institution. An “Institution Select” option may be included and preferably is active only for power users and administrators, as users typically may be logged in only at their Institutions page.

A “Changing the Year” parameter may trigger a page refresh with a new dataset. Changing the companies selected may trigger either a page refresh or an inline AJAX update of the page data.

A “Company Multi-select” option may be included for power users, for instance. It would be preferable to have a checkbox next to the names in the list to easily indicate to the user that they may select many companies, rather than use an ordinary multi-select list. Selected companies may show a checked box and may have their row highlighted. Clicking the company may check the box, update the related graphs (see below) and highlight the row. The list of companies may include those which made payments to the user's institution or physicians at that institution. The amount shown may reflect the sum of all payments to the institution selected for the year selected. The companies may be ordered by the amounts in descending order.

There may also be an “all companies” option. Selecting additional or different companies may cause, for example, one or more of the following updates to the screen: (1) Total payment comparison graph may be updated; (2) Payments by activity may be updated; (3) Highest paid pros may be updated; and (4) Payment trends may be updated with data for the companies selected. If more than a pre-determined number of companies are selected, this graph may say “too many data series to display” or something to that effect, depending on the implementation.

The System may display, for example, a “Total Payments vs. Peers/state/zip Graph” per institution, company, year selected, and the chosen peer group. The peer group pillar may be excluded also. In an exemplary embodiment, three series of data are plotted against a percentile. Percentile calculations reflect what percentage of a set of values are less than or equal to the value in question. The 50th percentile is the median, a value in the 75th percentile means that 75% of all values are lower than the value in question, and so forth. An exemplary calculation for percentile is provided in the '705 application.

The System also may display a “Payments by Activity Graph” per companies and year selected. The percent/total select may work similarly to the existing mechanisms on the physician payment report page. Other parameters may include an Institution Peer Group listing chosen by the website operator. It may show, for instance, the five institutions whose total payment amounts are closest to the current institution based on the current year and companies selected. The System also may offer a “Highest Paid Professionals Multi-select” per year, and companies selected, ordered by total amount, descending. The top X control would update the list with the top X number of physicians. Selecting a professional may cause a pop-up of their payment page. The list may be like a peer group list in that it may be just a listing of names, but with a link to their payment page.

In addition, the System may include a “Payment Trends by Company Graph” that shows the amounts per institution selected, year selected and company(s) selected. It may show multiple companies if multiples are selected. Changing the date range may update only this graph and may ignore the year selected at the top of the page.

Payment Analysis by Professional

The System may include a screen providing “Payment Analysis by Professional” data. Such a screen may include a Healthcare Professional Select List, which may show all the physicians under the current office/institution. Selecting a physician may redraw the data-display widgets on the page to be specific to that physician. A “Year Select” option shows the years that contain transaction data for the physician selected, and it may be empty until a physician is selected. A “Select Company Multi-select” may function virtually identically to the similar company select on the Analysis by Institution page. An exemplary company list identifies the companies that made payments to the selected physician. The System also may display a “Total Payments Compared to Other Professionals” report that may function virtually identically to the similar graph of institutions on the Analysis by Institution page, per physician, company, and year selected. For instance, three series of data comparisons may be available: the physicians within the institution (same method used to generate the professional select pulldown), physicians in the same state, and all the physicians in the US (all physicians).

As with the Payment Analysis by Institution, the three series of data may be plotted against a percentile. Percentile calculations reflect what percentage of a set of values are less than or equal to the value in question. The 50th percentile is the median, a value in the 75th percentile means that 75% of all values are lower than the value in question, and so forth. An exemplary calculation for percentile is provided in the '705 application.

The System may include an option providing “Payments By Activity” that may be depicted, for example, as a pie chart showing the payments for the companies selected to the physician for the year selected, broken down by payment purpose. The pie chart may toggle between percentage and total amount via Javascript; similar pie charts on the physician report page may function similarly. Selection of a “Peer Group—Professionals” may be an automatically selected group of professionals who made similar amounts per year and company(s) selected. In addition, a “Payment Trends By Company” may be provided as a line graph displaying payment summaries made by year to this physician by the companies selected.

Payment Analysis by Company

The System may include a screen providing “Payment Analysis by Company” data. This screen may be presented, for instance, to a logged in institutional administrator. It may be linked to or from an “administrator landing” page. This page may show detailed payment information per company and per company and physician.

A “Company Select” option may be provided, wherein changing this value may refresh the screen to display information related to that company only. On an initial visit to the page, it may say “choose one,” and all the graphs below may be empty. A “Year Select” option also may be provided, wherein changing this value may refresh the screen to display information related to that year only. The available values may be dependent upon the years available for the company selected, and if none are available, the select box may be disabled. It may default to “all years.” In some cases, a “Month Select” option may limit data to the selected month. These data are dependent on month data that may be omitted if absent. A “State Select” option likewise may be provided, wherein changing this value may refresh the screen to display information related to transactions involving offices in the state selected only. It may default to “all states.”

The System may display “Total Payments by Institution” for the ‘company’, ‘year’, and ‘state’ values selected, which displays a list of Institutions/offices where the name is not empty, ordered by the sum total value of the transactions, both public and private, involving those offices for the company, year, and state selected. This list may be blank until a company has been selected. Selecting a company (or multiple companies) may update the physician list (payments to professional) and the Payments by Activity graphs.

The System also may display “Total Payments by Professional” for the company, year, and institution selected, which may show the highest paid doctors (where name isn't empty), ordered by the sum amount of transactions, both public and private. An exemplary list is provided in the '705 application. Selecting a name (or more) from the list may do a refresh of the Payments by Activity graph directly below it.

In some embodiments, the System may provide a “My Institution rank” option. For instance, below the “Total Payments by Institution” may be a box with the logged-in user's institution, amount, and rank. If there are no data for that institution, the box may disappear.

Similarly, the System may display “Payments by Activity” that may be broken down into left and right areas. For instance, on the left may be the data in “Total Payments by Institution” broken down by activity instead of institution. On the right, the selected physician's payments may be broken down by activity—similar or identical to the graph on the report page.

For instance, an exemplary embodiment may include a computer-implemented process of transforming and managing physician payment data for payments made to healthcare professional recipients by payers consisting of applicable group purchasing organizations and/or applicable manufacturers, wherein the process comprises: compiling identification data on the healthcare professional recipients from multiple sources into compiled recipient data; transforming the compiled recipient data into transformed recipient data that conform to a structured format of a recipient database; creating a recipient database from the transformed recipient data; processing the transformed recipient data into processed recipient data; compiling the physician payment data from multiple sources into compiled payment data; transforming the compiled payment data into transformed payment data that conform to a desired format of a payment database; creating a payment database from the transformed payment data; processing the transformed payment data into processed payment data; and relating the recipient database and the payment database.

The exemplary process may further comprise: compiling payer data on the payers from multiple sources into compiled payer data; transforming the compiled payer data into transformed payer data that conform to a selected format of a payer database; creating a payer database from the transformed payer data; processing the transformed payer data into processed payer data; and relating the payer database to the recipient database and the payment database.

In addition, the exemplary process may further include one or more of the following: managing the processed payer data on a payment-level to view, edit and/or delete selected data; managing the processed payer data on a recipient-level to view, edit and/or delete selected data; managing the processed recipient data on a payment-level to view, edit and/or delete selected data; managing the processed recipient data on a payer-level to view, edit and/or delete selected data; managing the processed payment data on a recipient-level to view, edit and/or delete selected data; and managing the processed payment data on a payer-level to view, edit and/or delete selected data.

The foregoing description discloses exemplary embodiments of the invention. While the invention herein disclosed has been described by means of specific embodiments and applications thereof, numerous modifications and variations could be made thereto by those skilled in the art without departing from the scope of the invention set forth in the claims. Modifications of the above disclosed apparatus and methods that fall within the scope of the invention will be readily apparent to those of ordinary skill in the art. Accordingly, other embodiments may fall within the spirit and scope of the invention, as defined by the following claims.

In the description above, numerous specific details are set forth in order to provide a more thorough understanding of embodiments of the invention. It will be apparent, however, to an artisan of ordinary skill that the present invention may be practiced without incorporating all aspects of the specific details described herein. In other instances, specific details well known to those of ordinary skill in the art have not been described in detail so as not to obscure the invention. Readers should note that although examples of the invention are set forth herein, the claims, and the full scope of any equivalents, are what define the metes and bounds of the invention.

What is claimed is:

1. A computer-implemented method of transforming and managing physician payment data for payments made to healthcare professional recipients by payers consisting of applicable group purchasing organizations and/or applicable pharmaceutical and medical device manufacturers, the method comprising:
compiling the physician payment data from multiple sources into compiled payment data;
transforming the compiled payment data into transformed payment data that conform to a desired format of a computer database;
creating the computer database from the transformed payment data;
processing the transformed payment data into processed payment data within the database; and
providing access to the computer database.

2. The method of claim 1, wherein compiling the physician payment data comprises:
automatedly acquiring physician payment data from the internet, from paper records, and/or from user entries;
collecting the physician payment data as raw source files; and
cataloging the source files.

3. The method of claim 2, wherein automatedly acquiring physician payment data comprises:
performing an automated internet search for physician payment data available electronically via the internet; and
acquiring a copy of the physician payment data available electronically via the internet.

4. The method of claim 1, wherein transforming the compiled payment data comprises:
organizing the compiled payment data into a database structure of delimited text;
formatting the compiled payment data within the database structure; and
categorizing the compiled payment data within the database structure.

5. The method of claim 1, wherein creating the computer database from the transformed payment data comprises:
importing the transformed payment data into the computer database; and
reconciling transformed payment data that present problems during importing.

6. The method of claim 1, wherein processing the transformed payment data comprises:
cleansing the transformed payment data; and
de-duping the transformed payment data to remove duplicate data.

7. The method of claim 1, wherein providing access to the computer database comprises:
verifying user credentials via log-on;
matching user credentials with access limitations; and
applying access limitations during user interaction with the computer database.

8. The method of claim 1, further comprising:
tracking specific processed payment data within the database back to specific physician payment data from a specific source.

9. The method of claim 8, wherein providing access to the computer database comprises:
providing access to a raw source file from the specific source from which specific physician payment data were acquired that resulted in specific processed payment data within the database.

10. The method of claim 1, further comprising:
managing the processed payment data on a recipient-level to view, edit and/or delete selected data.

11. The method of claim 1, further comprising:
managing the processed payment data on a payer-level to view, edit and/or delete selected data.

12. A computer-implemented system of transforming and managing physician payment data for payments made to healthcare professional recipients by payers consisting of applicable group purchasing organizations and/or applicable manufacturers, the system comprising computer hardware programmed to:
compile the physician payment data from multiple sources into compiled payment data;
transform the compiled payment data into transformed payment data that conform to a desired format of a computer database;
create a computer database from the transformed payment data;
process the transformed payment data into processed payment data; and
provide access to the computer database.

13. The system of claim 12,
wherein to compile the physician payment data comprises to:
automatedly acquire physician payment data from the internet, from paper records, and/or from user entries;
collect the physician payment data as raw source files; and
catalog the source files;
and wherein to transform the compiled payment data comprises to:
organize the compiled payment data into a database structure of delimited text;
format the compiled payment data within the database structure; and
categorize the compiled payment data within the database structure.

14. The system of claim 12,
wherein to create the computer database from the transformed payment data comprises to:
import the transformed payment data into the computer database; and
reconcile transformed payment data that present problems during importing;
and wherein to process the transformed payment data comprises to:
cleanse the transformed payment data; and
de-dupe the transformed payment data to remove duplicate data.

15. The system of claim 12, wherein to provide access to the computer database comprises to:
verify user credentials via log-on;
match user credentials with access limitations; and
apply access limitations during user interaction with the computer database.

16. The system of claim 12, further comprising computer hardware programmed to:
track specific processed payment data within the database back to specific physician payment data from a specific source.

17. A computer-implemented process of transforming and managing physician payment data for payments made to healthcare professional recipients by payers consisting of applicable group purchasing organizations and/or applicable manufacturers, the process comprising:
compiling identification data on the healthcare professional recipients from multiple sources into compiled recipient data;
transforming the compiled recipient data into transformed recipient data that conform to a structured format of a recipient database;
creating a recipient database from the transformed recipient data;
processing the transformed recipient data into processed recipient data;
compiling the physician payment data from multiple sources into compiled payment data;
transforming the compiled payment data into transformed payment data that conform to a desired format of a payment database;
creating a payment database from the transformed payment data;
processing the transformed payment data into processed payment data; and
relating the recipient database and the payment database.

18. The process of claim 17, further comprising:
compiling payer data on the payers from multiple sources into compiled payer data;
transforming the compiled payer data into transformed payer data that conform to a selected format of a payer database;
creating a payer database from the transformed payer data;
processing the transformed payer data into processed payer data; and
relating the payer database to the recipient database and the payment database.

19. The process of claim 18, further comprising:
managing the processed recipient data on a payment-level to view, edit and/or delete selected data.

20. The process of claim 18, further comprising:
managing the processed recipient data on a payer-level to view, edit and/or delete selected data.
